(19) United States
(12) Patent Application Publication
(10) Pub. No.: US 2015/0296495 A1
(43) Pub. Date: Oct. 15, 2015

(54) RADIO COMMUNICATION SYSTEM AND COMMUNICATION CONTROL METHOD

(71) Applicant: NTT DOCOMO, INC., Tokyo (JP)

(72) Inventors: Hiroto Yasuda, Tokyo (JP); Yasufumi Morioka, Tokyo (JP); Jinho Kim, Tokyo (JP); Hideaki Takahashi, Tokyo (JP); Yukihiko Okumura, Tokyo (JP); Hiroyuki Ishii, Palo Alto, CA (US)

(21) Appl. No.: 14/441,531

(22) PCT Filed: Oct. 4, 2013
(86) PCT No.: PCT/JP2013/077087

§ 371 Date: May 8, 2015

(30) Foreign Application Priority Data
Nov. 8, 2012 (JP) 2012-246303

(51) Int. Cl. H04W 72/04

(52) U.S. Cl. CPC H04W 72/0406; H04W 88/08

(57) ABSTRACT

A radio communication system includes at least one user equipment, multiple base stations including a first base station that can execute radio resource control of the user equipment, a second base station that does not execute radio resource control of the user equipment, at least one gateway apparatus, and a switching station that controls a user plane path. The switching station transmits a non-access stratum message to the user equipment through a control plane path established between the first base station and the user equipment in a case in which it is decided that the user plane path should be released, the non-access stratum message instructing the user equipment to release the user plane path.

### FIELD OF THE INVENTION

The present invention relates to a radio communication system and to a communication control method.

### BACKGROUND ART

Various radio communication systems complying with the 3GPP (Third Generation Partnership Project) standards have been utilized. In radio communication systems complying with the LTE/SAE (Long Term Evolution/System Architecture Evolution) standards among the 3GPP standards, a user plane path, which is a logical communication path used for communicating user data, is established between a user equipment and a gateway apparatus via a radio base station. The user plane path is controlled (established, changed, released, etc.) by a switching station (MME (Mobility Management Entity)) in the radio communication system through a control plane path, which is a logical communication path used for communicating control data.

In radio communication systems complying with conventional LTE/SAE standards, eNBs (evolved Node Bs) are used for radio base stations that can directly communicate with user equipments. Each eNB has control plane paths to the switching station, other eNBs, and user equipments. The switching station and user equipments are not directly connected wirelessly. Accordingly, the switching station executes control of the above-mentioned user plane paths by exchanging control messages with user equipments through eNBs.

### RELATED ART DOCUMENTS

### Non-patent Documents

Non-patent Document 1: 3GPP TS 36.300 V10.6.0 (2011-12), 3rd Generation Partnership Project; Technical Specification Group Radio Access Network; Evolved Universal Terrestrial Radio Access (E-UTRA) and Evolved Universal Terrestrial Radio Access Network (E-UTRAN); Overall description; Stage 2 (Release 10)

### SUMMARY OF THE INVENTION

### Problems to be Solved by the Invention

Let us assume that a radio communication system includes, in addition to the above-mentioned base stations (eNBs), a new type of base station (base stations having limited control functions) that does not have part of control plane paths (for example, control plane paths to user equipments). Such a base station that does not have control plane paths to user equipments cannot transmit or receive control messages to or from user equipments. Accordingly, in radio communication systems complying with conventional LTE/SAE standards, it is difficult to control user plane paths established through base stations having limited control functions.

Accordingly, it is an object of the present invention to perform control of a logical path established through a base station having limited control functions.

### Means for Solving the Problems

A radio communication system according to the present invention includes: at least one user equipment; multiple base stations including a first base station configured to execute radio resource control of the user equipment through a control plane path, which is a logical path established for the user equipment, and a second base station configured not to execute radio resource control of the user equipment; at least one gateway apparatus; and a switching station configured to control at least one user plane path, which is a logical path established between the user equipment and the gateway apparatus. The switching station includes: a decision unit configured to decide whether or not a user plane path having been established between the user equipment and the gateway apparatus via the second base station should be released; and a communication controller configured to transmit a non-access stratum message to the user equipment through the control plane path established between the first base station and the user equipment in a case in which the decision unit decides that the user plane path should be released, the non-access stratum message instructing the user equipment to release the user plane path.

In a preferred embodiment of the present invention, the communication controller of the switching station is configured to transmit a path release request message including an identifier of the user plane path to be released and the non-access stratum message to the first base station in a case in which the decision unit decides that the user plane path should be released. The first base station includes: a base station controller configured to transmit a path release request message for the second base station on the basis of the path release request message received from the switching station; and a radio controller configured to transmit a radio resource control message including the non-access stratum message included in the path release request message received from the switching station to the user equipment. The second base station includes: a communication controller configured to release the user plane path corresponding to the identifier and established via the second base station, on the basis of the path release request message for the second base station received from the first base station. The user equipment includes: a radio controller configured to release the user plane path, on the basis of the non-access stratum message included in the radio resource control message received from the first base station.

In a preferred embodiment of the present invention, the base station controller of the first base station is configured to separate the identifier of the user plane path to be released from the path release request message received from the switching station, to include the identifier in the path release request message for the second base station, and to transmit the path release request message for the second base station to the second base station. The radio controller of the first base station is configured to separate the non-access stratum message from the path release request message received from the switching station, to include the non-access stratum message in the radio resource control message, and to transmit the radio resource control message to the user equipment.

In a preferred embodiment of the present invention, the communication controller of the switching station is configured to transmit a first path release request message including the identifier of the user plane path to be released to the second base station, and to transmit a second path release request message including the non-access stratum message to the first base station in a case in which the decision unit decides that the user plane path should be released. The second base station includes: a communication controller configured to release the user plane path corresponding to the identifier and established via the second base station, on the basis of the first path release request message received from the switching station. The first base station includes: a radio controller configured to transmit a radio resource control message including the non-access stratum message included in the second path release request message received from the switching station to the user equipment. The user equipment includes: a radio controller configured to release the user plane path, on the basis of the non-access stratum message included in the radio resource control message received from the first base station.

In a preferable embodiment of the present invention, the communication controller of the switching station is configured to transmit a path release request message including an identifier of the user plane path to be released and the non-access stratum message to the second base station in a case in which the decision unit decides that the user plane path should be released. The second base station includes: a communication controller configured to release the user plane path corresponding to the identifier and established via the second base station, on the basis of the path release request message received from the switching station; and a base station controller configured to transmit a path release request message for the first base station including the non-access stratum message. The first base station includes: a radio controller configured to transmit a radio resource control message including the non-access stratum message included in the path release request message for the first base station received from the second base station to the user equipment. The user equipment includes: a radio controller configured to release the user plane path, on the basis of the non-access stratum message included in the radio resource control message received from the first base station.

In a preferable embodiment of the present invention, the radio controller of the second base station is configured to separate the non-access stratum message from the path release request message received from the switching station, to include the non-access stratum message in the path release request message for the first base station, and to transmit the path release request message for the first base station to the first base station.

A communication control method according to the present invention is a communication control method in a radio communication system including: at least one user equipment; multiple base stations including a first base station configured to execute radio resource control of the user equipment through a control plane path, which is a logical path established for the user equipment, and a second base station configured not to execute radio resource control of the user equipment; at least one gateway apparatus; and a switching station configured to control at least one user plane path, which is a logical path established between the user equipment and the gateway apparatus. The communication control method includes: at the switching station, deciding whether or not a user plane path having been established between the user equipment and the gateway apparatus via the second base station should be released; and transmitting a non-access stratum message to the user equipment through the control plane path established between the first base station and the user equipment in a case in which it is decided that the user plane path should be released, the non-access stratum message instructing the user equipment to release the user plane path.

### Effects of the Invention

With the above-described structure, even when a user plane path has been established via the second base station, which cannot transmit a non-access stratum message to user equipment, it is possible to transmit a non-access stratum message for instructing to control (release) the user plane path to the user equipment through the first base station. Accordingly, it is possible to control (release) the user plane path having been established via the second base station.

### BRIEF DESCRIPTION OF THE DRAWINGS

FIG. 1 is a block diagram showing a radio communication system according to a first embodiment of the present invention;

FIG. 2 is an explanatory diagram of the protocol architecture used in the radio communication system;

FIG. 3 is a flow diagram showing an example of a release operation of a PDN connection according to the first embodiment;

FIG. 4 is a diagram showing an example of the format of a Deactivate Bearer Request message;

FIG. 5 is a diagram showing an example of the format of a Deactivate Bearer Request message after separation;

FIG. 6 is a flow diagram showing an example of a release operation of a PDN connection according to the first embodiment;

FIG. 7 is a block diagram showing the structure of a user equipment according to the first embodiment;

FIG. 8 is a block diagram showing the structure of a first base station according to the first embodiment;

FIG. 9 is a block diagram showing the structure of a second base station according to the first embodiment;

FIG. 10 is a block diagram showing the structure of a switching station according to the first embodiment;

FIG. 11 is a block diagram showing the structure of a gateway apparatus according to the first embodiment;

FIG. 12 is a block diagram showing a radio communication system according to a second embodiment of the present invention;

FIG. 13 is a flow diagram showing an example of a release operation of a PDN connection according to the second embodiment;

FIG. 14 is a diagram showing an example of the format of a Deactivate Bearer Request message;

FIG. 15 is a flow diagram showing an example of a release operation of a PDN connection according to the second embodiment;

FIG. 16 is a block diagram showing a radio communication system according to a third embodiment of the present invention;

FIG. 17 is a flow diagram showing an example of a release operation of a PDN connection according to the third embodiment;

FIG. 18 is a block diagram showing the structure of a second base station according to the third embodiment; and

FIG. 19 is a diagram showing an example of a formation of cells formed by base stations.

### DESCRIPTION OF EMBODIMENTS

### 1. First Embodiment

1(1). Structure of Radio Communication System

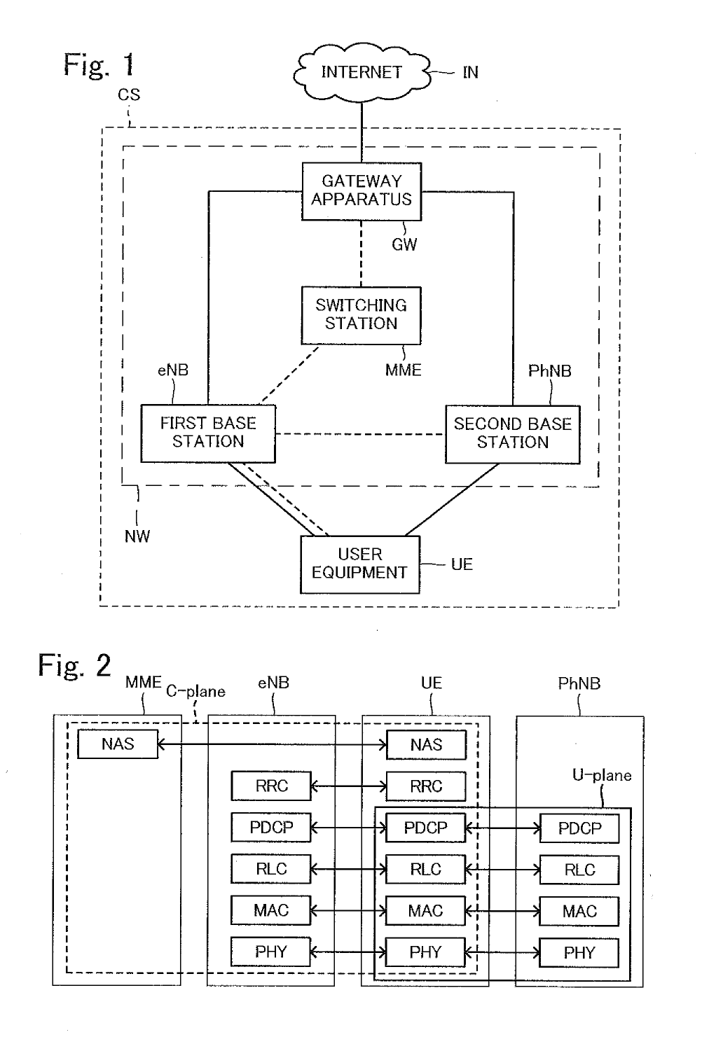

FIG. 1 is a block diagram showing the structure of a radio communication system CS according to the first embodiment of the present invention. The radio communication system CS includes, as its elements, at least one user equipment UE, a first base station eNB, a second base station PhNB, a switching station MME, and a gateway apparatus GW. A network NW includes all elements of the radio communication system CS, except for the user equipment UE.

Each element in the radio communication system CS performs communication in compliance with a predetermined access technology, for example, the LTE/SAE (Long Term Evolution/System Architecture Evolution) included in the 3GPP (Third Generation Partnership Project) standards. According to terms defined in the 3GPP standards, the user equipment UE is a user equipment, the first base station eNB is an evolved Node B, the switching station MME is a mobile management entity, and the gateway apparatus GW is a Packet-Data-Network/Serving Gateway, i.e., an SAE gateway. The second base station PhNB is a base station that depends on the first base station eNB for some or all of the control functions (details will be described later).

In connection with the present embodiment, an aspect in which the radio communication system CS operates in principle in compliance with LTE/SAE is exemplified, but this is not intended to limit the technical scope of the present invention. The present invention can be used with other radio access technologies with necessary design modifications.

The user equipment UE can execute wireless communication with the first base station eNB and the second base station PhNB. The scheme for radio communication between the user equipment UE and each base station (eNB and PhNB) may be freely chosen. For example, OFDMA (Orthogonal Frequency Division Multiple Access) may be adopted for downlink, whereas SC-FDMA (Single-Carrier Frequency Division Multiple Access) may be adopted for uplink. In addition, the scheme of radio communication used by the first base station eNB may be different from the scheme of radio communication used by the second base station PhNB.

The first base station eNB is connected with the second base station PhNB, the switching station MME, and the gateway apparatus GW. The second base station PhNB is connected with the first base station eNB and gateway apparatus GW. The gateway apparatus GW is connected with the first base station eNB, the second base station PhNB, and switching station MME, and also connected with the Internet IN, which is a network external to the radio communication system CS. In other words, the gateway apparatus GW serves as a connection point (access point) with an external network. The above-mentioned connections are typically wired connections, but some or all of the above-mentioned connections may be wireless connections.

1(2). Exchange of User Signals and Control Signals

Exchange of user signals and control signals in the radio communication system CS will be described. In FIG. 1, the solid lines show paths used for transmission and reception of user signals (signals indicating user data, such as voice signals, data signals, etc.), whereas dashed lines show paths used for transmission and reception of control signals (control messages). In other words, the solid lines show interfaces of the U-plane (user plane), whereas the dashed lines show interfaces of the C-plane (control plane). A U-plane path is established via a U-plane interface, whereas a C-plane path is established via a C-plane interface.

In the above structure, an X3 interface exists between the first base station eNB and the second base station PhNB, whereas a Ph-U interface exists between the second base station PhNB and the user equipment UE. However, a C-plane interface does not exist between the second base station PhNB and the user equipment UE.

In the radio communication system CS, user signals are exchanged through bearers that are logical paths. A bearer (EPS bearer) is established between the user equipment UE and the gateway apparatus GW on the basis of control of the switching station MME (control signals sent from the switching station MME). A PDN connection PC that is an IP session established from the user equipment UE to the external network (the Internet IN) via the gateway apparatus GW involves one or more bearers (EPS bearers).

The user equipment UE can communicate with the Internet IN using the PDN connection PC through the first base station eNB and the gateway apparatus GW, and can also communicate with the Internet IN using the PDN connection PC through the second base station PhNB and the gateway apparatus GW.

An EPS bearer includes a radio bearer RB and an S1 bearer S1B. The radio bearer RB is a bearer established between the user equipment UE and the base station (the first base station eNB or the second base station PhNB), whereas the S1 bearer S1B is a bearer established between the base station (the first base station eNB or the second base station PhNB) and the gateway apparatus GW. The path of the established EPS bearer (U-plane path) can be changed and released on the basis of control by the switching station MME.

Each node within the radio communication system CS has unique identification information. Such identification information may include the IP address, the TEID (Tunnel Endpoint IDentifier), network address, etc. of the node. In addition, identification information of the first base station eNB and the second base station PhNB can include the physical cell ID that identifies the cell C formed by the corresponding base station. The IP address is an address value for uniquely identifying the node in the radio communication system CS. The TEID is an identifier for identifying the endpoint of the bearer (GTP tunnel) logically connecting nodes. The network address is an address value for identifying a subnet to which the node belongs in a case in which the radio communication system CS is divided into multiple subnets. Each node within the radio communication system CS distinguishes another node on the basis of identification information of the other node, and can transmit and receive signals to and from the distinguished node.

1(3). C-Plane and U-Plane Separation

FIG. 2 is an explanatory diagram of the protocol architecture (protocol stack) used in the radio communication system CS of the present embodiment. The protocol stack in FIG. 2 includes the physical layer (PHY), the media access control layer (MAC), the radio link control layer (RLC), the packet data convergence protocol layer (PDCP), the radio resource control layer (RRC), and the non-access stratum (NAS) in the order from lower to higher, from the lowest to the highest. This stratum structure is the same as that stipulated in the LTE/SAE.

In the radio communication system CS of the present embodiment, for the single user equipment UE, it is possible to set the C-plane path and the U-plane path via different base stations; in other words, it is possible to separate the C-plane and the U-plane. FIG. 2 shows a state in which the C-plane path is established between the user equipment UE and the switching station MME via the first base station eNB and in which the U-plane path is established between the user equipment UE and the gateway apparatus GW via the second base station PhNB.

As shown in FIG. 2, four layers from the physical layer (PITY) to the packet data convergence protocol layer (PDCP) are common for the C-plane and the U-plane. In the U-plane, exchange of user data is executed between nodes connected in layers from the physical layer (PHY) to the packet data convergence protocol layer (PDCP).

On the other hand, in the C-plane, there are the radio resource control layer (RRC) and the non-access stratum (NAS) above the above-mentioned four layers. The first base station eNB controls radio resources used by the user equipment UE (for example, the radio bearer RB) by transmitting control messages of the radio resource control layer (for example, RRC Connection Reconfiguration, which will be described later) to the user equipment UE. The switching station MME controls logical resources used by the user equipment UE (for example, the PDN connection PC) by transmitting control messages of the non-access stratum (for example, Deactivate EPS Bearer Context Request, which will be described later) to the user equipment UE. Control messages of the non-access stratum are included in control messages of the radio resource control layer that the first base station eNB generates, and are forwarded to the user equipment UE.

The second base station PhNB, which does not have the radio resource control layer, cannot transmit control messages of the radio resource control layer to the user equipment UE. Thus, the second base station PhNB cannot forward control messages of the non-access stratum from the switching station MME to the user equipment UE.

1(4). Release Operation of PDN Connection

### 1(4)-1. Operation Example 1-1

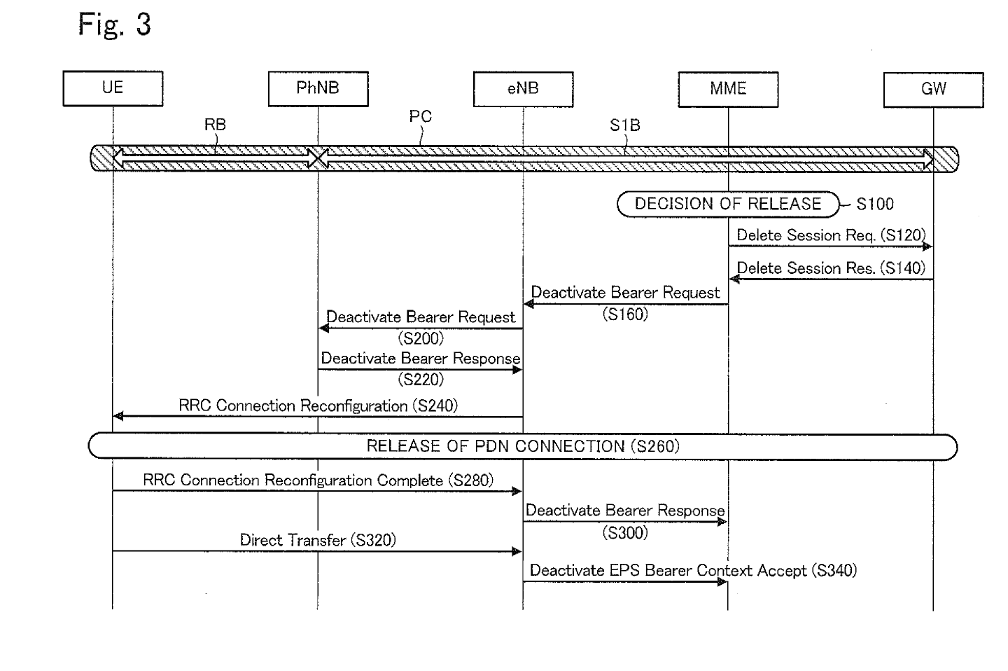

With reference to FIGS. 3 to 5, an example of release operation of the PDN connection PC according to the first embodiment will be described. In general, based on a path release request message from the switching station MME, the first base station eNB controls the second base station PhNB and the user equipment UE to release the PDN connection PC.

FIG. 3 is a flow diagram showing an example of a release operation of a PDN connection PC. In the example in FIG. 3, assume that a C-plane path (not shown) has been established between the user equipment UE and the switching station MME via the first base station eNB, and that a U-plane path (PDN connection PC) has been established between the user equipment UE and the gateway apparatus GW via the second base station PhNB. One or more other PDN connections may have been in parallel to the PDN connection PC shown in FIG. 3.

The switching station MME decides whether or not the PDN connection PC should be released (S100). This decision at step S100 may be executed based on various criteria. For example, the switching station MME may decide that the PDN connection PC should be released if it receives a PDN Disconnection Request message transmitted from the user equipment UE through the C-plane path. This PDN Disconnection Request message may include the identifier of the PDN connection PC that should be released. Alternatively, the switching station MME may decide that the PDN connection PC should be released, for example, on the basis of information possessed by the switching station MME itself (for example, information indicating communication resources are lacking in the radio communication system CS).

After deciding that the PDN connection PC should be released at step S100, the switching station MME generates a Delete Session Request message for requesting to release the PDN connection PC, and sends it to the gateway apparatus GW (S120). The Delete Session Request message includes the identifier of the PDN connection PC that should be released. Upon receiving the Delete Session Request message, the gateway apparatus GW returns a Delete Session Response message to the switching station MME (S140), and executes a session completion procedure (Session Termination Procedure) to perform a release operation of the PDN connection PC. In other words, the gateway apparatus GW deletes context information (information necessary for establishment and maintenance of the PDN connection PC) regarding the PDN connection PC to be released that has been stored in the gateway apparatus GW itself.

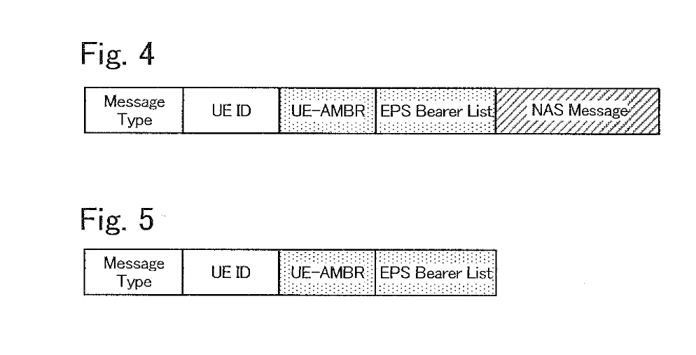

Upon receiving the Delete Session Response message from the gateway apparatus GW, the switching station MME generates a Deactivate Bearer Request message (path release request message) for requesting to release the PDN connection PC, and sends it to the first base station eNB (S160). FIG. 4 is a diagram showing an example of the format of the Deactivate Bearer Request message generated by the switching station MME. The Deactivate Bearer Request message contains the fields below:

a Message Type field indicating the type of message;

a UE ID field indicating the identifier of the user equipment UE for which the message is destined;

a UE-AMBR field indicating the total maximum bit rate on all bearers.

an EPS Bearer List field indicating the identifier of the EPS bearer (PDN connection PC) that should be released; and

a NAS Message field containing a Deactivate EPS Bearer Context Request message (a control message of the non-access stratum) destined for the user equipment UE.

The Deactivate EPS Bearer Context Request message contained in the NAS Message field is a message for instructing the user equipment UE to release the PDN connection PC.

Upon receiving the Deactivate Bearer Request message from the switching station MME, the first base station eNB generates another Deactivate Bearer Request message for the second base station PhNB on the basis of the received message, and sends it to the second base station PhNB (S200). More specifically, the first base station eNB generates a new Deactivate Bearer Request message shown in FIG. 5, and sends it to the second base station PhNB in a case in which the Deactivate Bearer Request message received from the switching station MME requests to release the PDN connection PC routed through the second base station PhNB. The new Deactivate Bearer Request message (FIG. 5) includes the Message Type field, the UE ID field, the UE-AMBR field, and the EPS Bearer List field, but does not include the NAS Message field.

As described above, at step S200, the first base station eNB separates (extracts) elements necessary for controlling the second base station PhNB from among the elements included in the Deactivate Bearer Request message from the switching station MME, and produces a new Deactivate Bearer Request message.

Upon receiving the Deactivate Bearer Request message from the first base station eNB, the second base station PhNB releases the PDN connection PC corresponding to the identifier indicated by the EPS Bearer List field included in the received message (i.e., deletes the context information on the PDN connection PC stored in the second base station PhNB). Then, the second base station PhNB transmits a Deactivate Bearer Response message to the first base station eNB (S220), the message indicating that release of the PDN connection PC has been completed at the second base station PhNB.

Upon receiving the Deactivate Bearer Response message from the second base station PhNB, the first base station eNB generates an RRC Connection Reconfiguration message (radio resource control message) on the basis of the Deactivate Bearer Request message received from the switching station MME at step S160, and sends it to the user equipment UE (S240). More specifically, the first base station eNB generates an RRC Connection Reconfiguration message that includes the non-access stratum control message contained in the NAS Message field of the Deactivate Bearer Request message from the switching station MME, and sends it to the user equipment UE via the C-plane path.

As described above, at step S240, the first base station eNB separates (extracts) elements necessary for controlling the user equipment UE from among the elements included in the Deactivate Bearer Request message from the switching station MME, and produces an RRC Connection Reconfiguration message.

Upon receiving the RRC Connection Reconfiguration message from the first base station eNB, the user equipment UE releases the PDN connection PC on the basis of the control message of the non-access stratum included in the received message. In other words, the user equipment UE deletes the context information on the PDN connection PC stored in the user equipment UE.

As described above, with regard to a PDN connection PC, context information stored in the gateway apparatus GW is deleted on the basis of the Delete Session Request message (S120), context information stored in the second base station PhNB is deleted on the basis of the Deactivate Bearer Request message (S200), and context information stored in the user equipment UE is deleted on the basis of the RRC Connection Reconfiguration message (S240). As a result, the PDN connection PC is fully released (S260).

Upon release of the PDN connection PC, the user equipment UE generates an RRC Connection Reconfiguration Complete message indicating that the release operation based on the RRC Connection Reconfiguration message has been completed, and sends it to the first base station eNB (S280). Upon receiving the RRC Connection Reconfiguration Complete message, the first base station eNB generates a Deactivate Bearer Response message indicating that the release operation based on the Deactivate Bearer Request message has been completed, and sends it to the switching station MME (S300). In addition, the user equipment UE generates a Deactivate EPS Bearer Context Accept message indicating that the release operation based on the Deactivate EPS Bearer Context Request message, includes the Deactivate EPS Bearer Context Accept message in a Direct Transfer message, and sends the Direct Transfer message to the first base station eNB (S320). The first base station eNB forwards the Deactivate EPS Bearer Context Accept message included in the Direct Transfer message to the switching station MME (S340).

### 1(4)-2. Operation Example 1-2

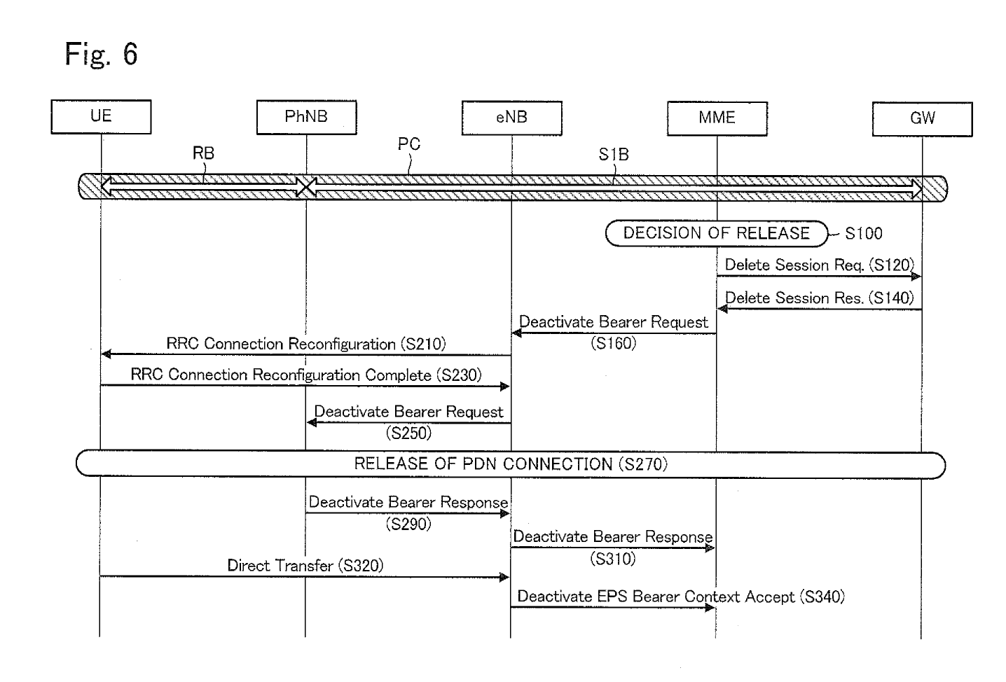

FIG. 6 is a flow diagram showing another example of a release operation of a PDN connection PC. Step S100 to step S160 are the same as those in the example of FIG. 3 (Operation Example 1-1), and therefore, description thereof will be omitted.

Upon receiving the Deactivate Bearer Request message from the switching station MME, the first base station eNB generates an RRC Connection Reconfiguration message (radio resource control message) on the basis of the received message in a manner similar to step S240 of Operation Example 1-1, and sends it to the user equipment UE (S210). In the same manner as in Operation Example 1-1, the user equipment UE deletes the context information on the PDN connection PC stored in the user equipment UE, and sends an RRC Connection Reconfiguration Complete message to the first base station eNB (S230).

Upon receiving the RRC Connection Reconfiguration Complete message from the user equipment UE, the first base station eNB generates a Deactivate Bearer Request message for the second base station PhNB on the basis of the Deactivate Bearer Request message received from the switching station MME at step S160, and sends it to the second base station PhNB (S250). The specific process is the same as step S200 in Operation Example 1-1. Upon receiving the Deactivate Bearer Request message from the first base station eNB, in the same manner as in Operation Example 1-1, the second base station PhNB deletes the context information on the PDN connection PC stored in the second base station PhNB.

As described above, in a manner similar to Operation Example 1-1, context information with regard to a PDN connection PC stored in the gateway apparatus GW, the second base station PhNB, and the user equipment UE is deleted. As a result, the PDN connection PC is fully released (S270). Thereafter, control messages each indicating that release operation has been completed are sequentially exchanged (S290 to S340).

1(5). Structure of Each Element

1(5)-1. Structure of User Equipment

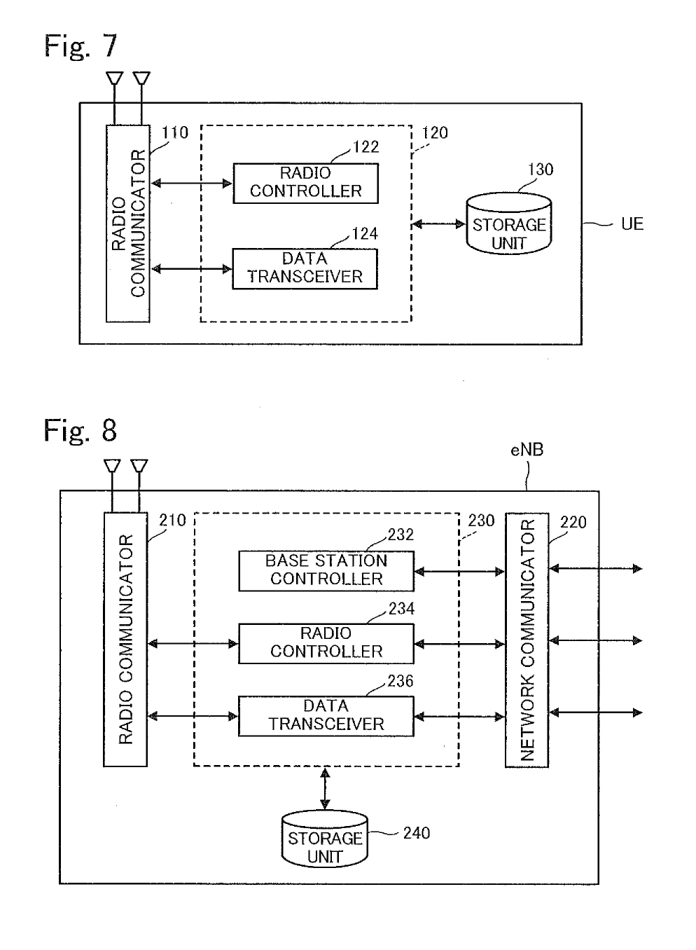

FIG. 7 is a block diagram showing the structure of the user equipment UE according to the present embodiment. The user equipment UE includes a radio communicator 110, a controller 120, and a storage unit 130. For the purpose of facilitating understanding, output devices for outputting sound, images, etc., and input devices for accepting user instructions, are omitted in FIG. 7.

The radio communicator 110 is an element for executing wireless communication with base stations (the first base station eNB and the second base station PhNB), and includes transceiving antennas, a reception circuit for receiving radio signals (radio waves) and converting them to electrical signals and a transmission circuit for converting electrical signals, such as control signals, data signals, to radio waves, and sending them. The storage unit 130 stores information on communication control, in particular, identification information on respective nodes including the user equipment UE itself and context information on the communication paths (the C-plane path and the U-plane path).

The controller 120 includes a radio controller 122 and a data transceiver 124. The radio controller 122 is an element for controlling communication between the user equipment UE and the base stations (the first base station eNB and the second base station PhNB), and transmits and receives control signals (control messages) via the radio communicator 110 to and from the base stations. In other words, the radio controller 122 executes communication in the C-plane. For example, the radio controller 122 releases the PDN connection PC (deletes the context information in the storage unit 130) on the basis of the received RRC Connection Reconfiguration Request message as described above. The data transceiver 124 transmits and receives data signals via the radio communicator 110 to and from the base stations, using an established PDN connection PC (EPS bearer). In other words, the data transceiver 124 executes communication in the U-plane.

The controller 120 and the radio controller 122 and the data transceiver 124 included in the controller 120 are functional blocks accomplished by the fact that a CPU (central processing unit, not shown) in the user equipment UE executes a computer program stored in the storage unit 130 and operates in accordance with the computer program.

1(5)-2. Structure of First Base Station

FIG. 8 is a block diagram showing the structure of the first base station eNB according to the present embodiment. The first base station eNB includes a radio communicator 210, a network communicator 220, a controller 230, and a storage unit 240. The radio communicator 210 is an element for executing wireless communication with the user equipment UE, and has a structure similar to that of the radio communicator 110 of the user equipment UE. The network communicator 220 is an element for executing communication with other nodes within the network NW (the second base station PhNB, the switching station MME, the gateway apparatus GW, etc.), and exchanges electrical signals with other nodes via cable or radio. The storage unit 240 stores information on communication control, in particular, identification information on respective nodes including the first base station eNB itself and context information on the communication paths (the C-plane path and the U-plane path).

The controller 230 includes a base station controller 232, a radio controller 234, and a data transceiver 236. The base station controller 232 is an element for controlling communication with other base stations (such as the second base station PhNB) on the basis of instructions (control messages) from upper nodes (such as the switching station MME), and exchanges control signals with the second base station PhNB and the switching station MME via the network communicator 220. The radio controller 234 is an element for controlling communication with the user equipment UE on the basis of instructions (control messages) from upper nodes (such as the switching station MME), exchanges control signals with the switching station MME via the network communicator 220, and exchanges control signals with the user equipment UE via the radio communicator 210. In other words, the base station controller 232 and the radio controller 234 execute communication in the C-plane. On the other hand, the data transceiver 236 uses an established PDN connection to transmit and receive (relay) user signals to and from the user equipment UE via the radio communicator 210 and to transmit and receive (relay) user signals to and from the gateway apparatus GW via the network communicator 220. In other words, the data transceiver 236 executes communication in the U-plane.

The controller 230 and the base station controller 232, the radio controller 234, and the data transceiver 236 included in the controller 230 are functional blocks accomplished by the fact that a CPU (not shown) in the first base station eNB executes a computer program stored in the storage unit 240 and operates in accordance with the computer program.

1(5)-3. Structure of Second Base Station

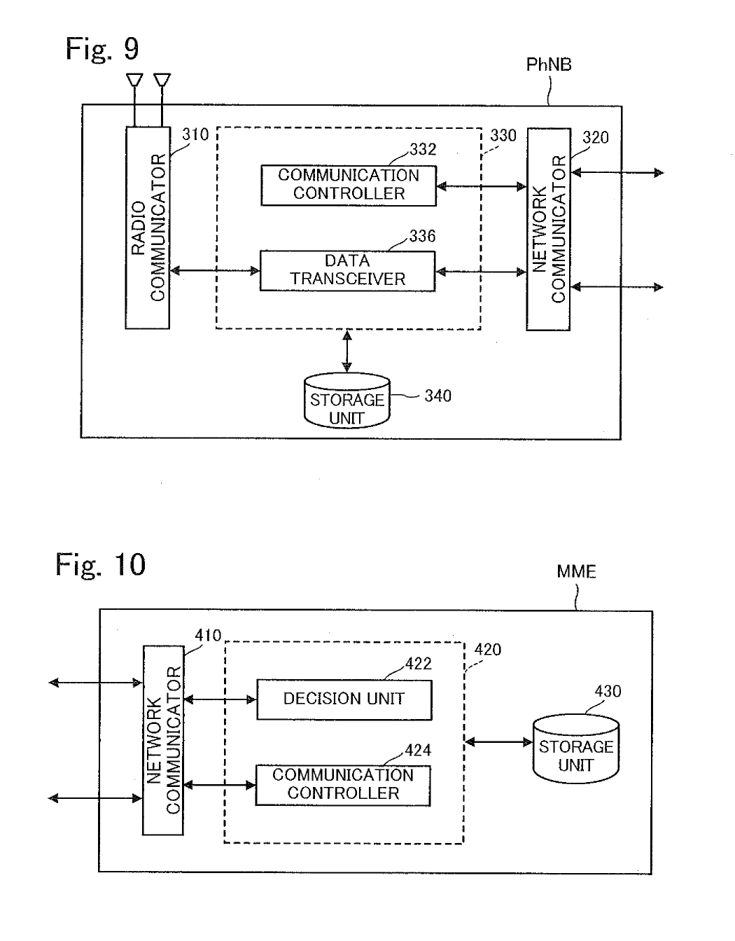

FIG. 9 is a block diagram showing the structure of the second base station PhNB according to the present embodiment. The second base station PhNB includes a radio communicator 310, a network communicator 320, a controller 330, and a storage unit 340. The radio communicator 310 is an element for executing wireless communication with the user equipment UE, and it has a structure similar to that of the radio communicator 210 of the first base station eNB. The network communicator 320 is an element for executing communication with the first base station eNB and the gateway apparatus GW, and exchanges electrical signals with the first base station eNB and the gateway apparatus GW via wire or wirelessly. The storage unit 340 stores information on communication control, in particular, identification information on respective nodes including the second base station PhNB itself and context information on the communication paths.

The controller 330 includes a communication controller 332 and a data transceiver 336. The communication controller 332 is an element for controlling communication passing through the second base station PhNB (for example, for controlling the PDN connection PC) on the basis of instructions (control message) from the upper node (the first base station eNB), and exchanges control signals with the first base station eNB via the network communicator 320. In other words, the communication controller 332 executes communication in the C-plane. However, the communication controller 332 does not execute radio resource control for the user equipment UE. The data transceiver 336 uses an established PDN connection to transmit and receive (relay) user signals to and from the user equipment UE via the radio communicator 310 and to transmit and receive (relay) user signals to and from the gateway apparatus GW via the network communicator 320. In other words, the data transceiver 336 executes communication in the U-plane.

The controller 330 and the communication controller 332 and the data transceiver 336 included in the controller 330 are functional blocks accomplished by the fact that a CPU (not shown) in the second base station PhNB executes a computer program stored in the storage unit 340 and operates in accordance with the computer program.

1(5)-4. Structure of Switching Station

FIG. 10 is a block diagram showing the structure of the switching station MME according to the present embodiment. The switching station MME includes a network communicator 410, a controller 420, and a storage unit 430. The network communicator 410 is an element for executing communication with other nodes within the network NW (the first base station eNB, the gateway apparatus GW, etc.), and has a structure similar to that of the network communicator 220 of the first base station eNB. The storage unit 430 stores information on communication control, in particular, identification information on respective nodes including the switching station MME itself and context information on the communication paths (the C-plane path and the U-plane path).

The controller 420 includes a decision unit 422 and a communication controller 424. The decision unit 422 decides whether the PDN connection PC should be released or not. The communication controller 424 is an element for controlling communication of the radio communication system CS, and exchanges control signals with the first base station eNB, the gateway apparatus GW, etc., via the network communicator 410. In addition, the communication controller 424 generates control messages of the non-access stratum (NAS) for the user equipment UE, and sends it to the user equipment UE through the first base station eNB. In other words, the controller 420 executes communication in the C-plane by means of the network communicator 410, and controls the logical communication path (U-plane path). However, the switching station MME (controller 420) does not execute communication in the U-plane.

The controller 420 and the decision unit 422 and the communication controller 424 included in the controller 420 are functional blocks accomplished by the fact that a CPU (not shown) in the switching station MME executes a computer program stored in the storage unit 430 and operates in accordance with the computer program.

1(5)-5. Structure of Gateway Apparatus

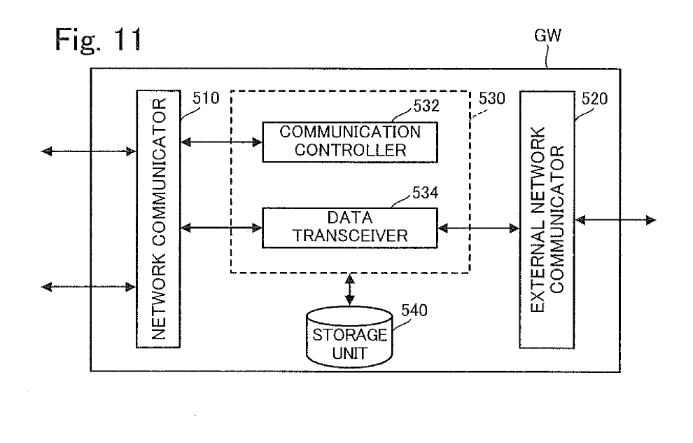

FIG. 11 is a block diagram showing the structure of the gateway apparatus GW according to the present embodiment. The gateway apparatus GW includes a network communicator 510, an external network communicator 520, a controller 530, and a storage unit 540. The network communicator 510 is an element for executing communication with other nodes within the network NW (the first base station eNB, the second base station PhNB, the switching station MME, etc.), and has a structure similar to that of the network communicator 220 of the first base station eNB. The external network communicator 520 is an element for executing communication with the Internet IN, and performs protocol conversion of user signals as needed. The storage unit 540 stores information on communication control, in particular, identification information on respective nodes including the gateway apparatus GW itself and context information on the communication paths (the C-plane path and the U-plane path).

The controller 530 includes a communication controller 532 and a data transceiver 534. The communication controller 532 is an element for executing communication control of the radio communication system CS, and exchanges control signals with the switching station MME via the network communicator 510 on the basis of a decision at the communication controller 532 itself or instructions (control messages) from other nodes (such as the switching station MME). In other words, the communication controller 532 executes communication in the C-plane by means of the network communicator 510. The data transceiver 534 transmits (relays) user signals that are originated from the user equipment UE and that are received via the network communicator 510 to the Internet IN (external server in the internet IN) via the external network communicator 520, and transmits (relays) user signals received from the Internet IN (external server in the internet IN) via the external network communicator 520 to the user equipment UE via the network communicator 510.

The controller 530 and the communication controller 532 and data transceiver 534 included in the controller 530 are functional blocks accomplished by the fact that a CPU (not shown) in the gateway apparatus GW executes a computer program stored in the storage unit 540 and operates in accordance with the computer program.

1(6). Effects of Present Embodiment

According to the above-described first embodiment, since the first base station eNB, on the basis of a path release request message from the switching station MME, controls the second base station PhNB and the user equipment UE so as to release a PDN connection PC (executes separation (extraction) from the path release request message), it is possible to release the PDN connection PC (U-plane path) having been established via the second base station PhNB, which cannot exchange control messages with the user equipment UE due to its limited control functions.

### 2. Second Embodiment

A second embodiment of the present invention will be described. In the respective embodiments that will be exemplified below, symbols referred to in the above description will be used for identifying elements equivalent to those of the first embodiment in action or function, and description for such elements will be omitted as appropriate.

2(1). Structure of Radio Communication System

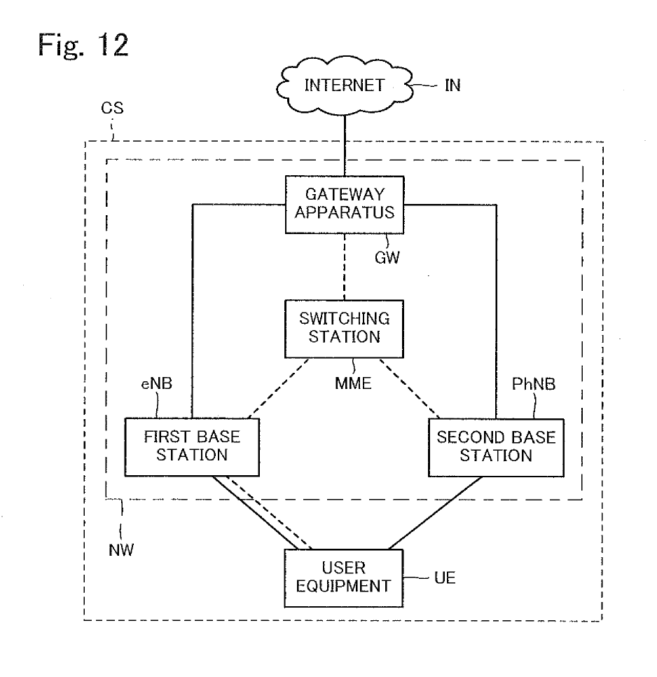

FIG. 12 is a block diagram showing a radio communication system CS according to the second embodiment of the present invention. The first base station eNB and the second base station PhNB according to the second embodiment are connected with the switching station MME and the gateway apparatus GW, respectively. C-plane interfaces exist between the first base station eNB and the switching station MME, and between the second base station PhNB and the switching station MME, respectively. In the same manner as in the first embodiment, a C-plane interface does not exist between the second base station PhNB and the user equipment UE.

2(2). Release Operation of PDN Connection

### 2(2)-1. Operation Example 2-1

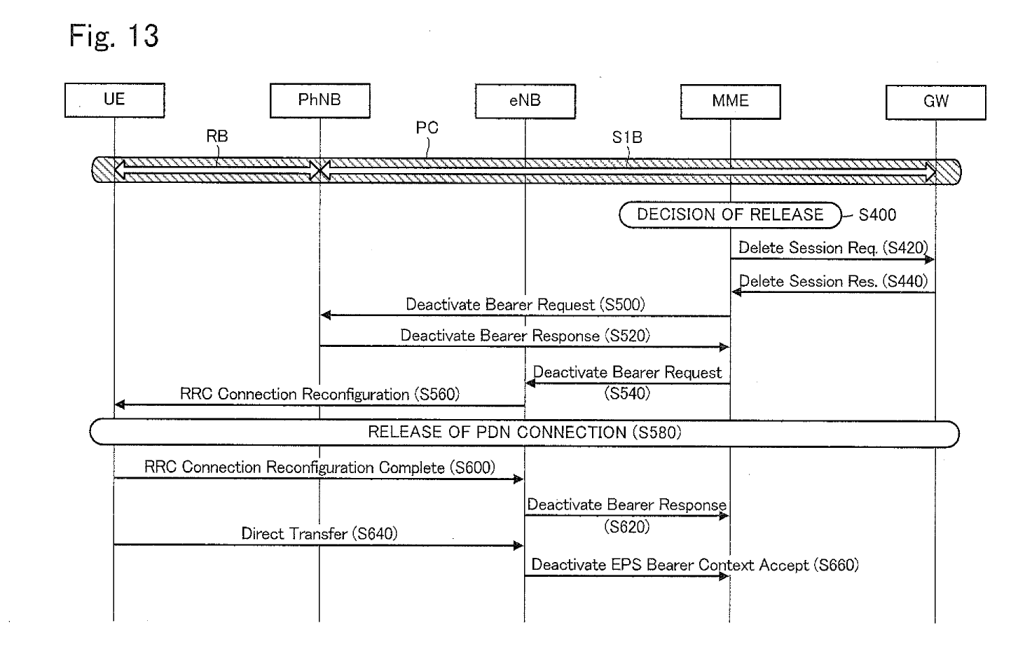

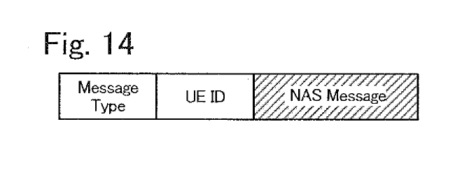

With reference to FIG. 13, FIG. 14, and FIG. 5, an example of a release operation of a PDN connection PC according to the second embodiment will be described. In general, the switching station MME controls the second base station PhNB and the user equipment UE so as to release a PDN connection PC (executes separation (extraction) of path release request messages). Control of the user equipment UE is made via the first base station eNB.

Since the first base station eNB according to the second embodiment does not execute separation (extraction) from a path release request message, or does not send control messages to the second base station PhNB, the first base station eNB does not need to include the base station controller 232.

FIG. 13 is a flow diagram showing an example of a release operation of a PDN connection. For the example in FIG. 13, in the same manner as for FIG. 3, assume that a C-plane path (not shown) has been established between the user equipment UE and the switching station MME via the first base station eNB, and that a PDN connection PC has been established between the user equipment UE and the gateway apparatus GW via the second base station PhNB. Step S400 to step S440 are the same as step S100 to step S140 in FIG. 3, and therefore, description thereof will be omitted.

Upon receiving the Delete Session Response message from the gateway apparatus GW, the switching station MME generates a Deactivate Bearer Request message (first path release request message) that includes the identifier of the PDN connection PC that should be released, and sends it to the second base station PhNB (S500). The format of the Deactivate Bearer Request message generated at step S500 is the same as that of the Deactivate Bearer Request message (FIG. 5) sent from the first base station eNB to the second base station PhNB at step S200 in the first embodiment (Operation Example 1-1).

Upon receiving the Deactivate Bearer Request message from the switching station MME, the second base station PhNB releases the PDN connection PC corresponding to the identifier indicated by the EPS Bearer List field included in the received message (i.e., deletes the context information on the PDN connection PC stored in the second base station PhNB). Then, the second base station PhNB transmits a Deactivate Bearer Response message to the switching station MME (S520), the message indicating that release of the PDN connection PC has been completed at the second base station PhNB.

Upon receiving the Deactivate Bearer Response message from the second base station PhNB, the switching station MME generates a Deactivate Bearer Request message (second path release request message), and sends it to the first base station eNB (S540). The format of the Deactivate Bearer Request message generated at step S540 is shown in FIG. 14. The Deactivate Bearer Request message contains a NAS Message field that includes a Deactivate EPS Bearer Context Request message (control message of the non-access stratum). The Deactivate EPS Bearer Context Request message is the same as in the first embodiment, and is a message for instructing the user equipment UE to release the PDN connection PC.

Upon receiving the Deactivate Bearer Request message from the switching station MME, on the basis of the received message, the first base station eNB generates an RRC Connection Reconfiguration message (radio resource control message), and sends it to the user equipment UE (S560). The specific process is the same as step S240 of the first embodiment. Upon receiving the RRC Connection Reconfiguration message from the first base station eNB, the user equipment UE releases the PDN connection PC on the basis of the control message of the non-access stratum included in the received message. In other words, the user equipment UE deletes the context information on the PDN connection PC stored in the user equipment UE.

As described above, in a manner similar to the first embodiment, context information with regard to a PDN connection PC stored in the gateway apparatus GW, the second base station PhNB, and the user equipment UE is deleted. As a result, the PDN connection PC is fully released (S580). Thereafter, control messages each indicating that release operation has been completed are sequentially exchanged (S600 to S660).

### 2(2)-2. Operation Example 2-2

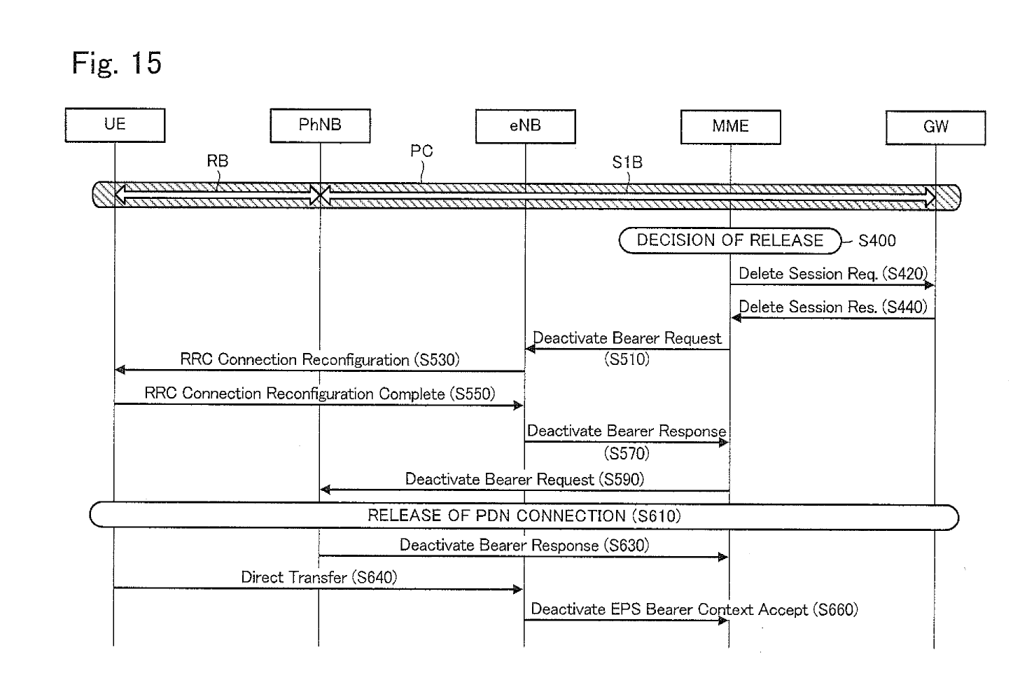

FIG. 15 is a flow diagram showing another example of a release operation of a PDN connection according to the second embodiment. Step S400 to step S440 are the same as those in the example of FIG. 13 (Operation Example 2-1), and therefore, description thereof will be omitted.

Upon receiving the Delete Session Response message from the gateway apparatus GW, the switching station MME generates a Deactivate Bearer Request message (second path release request message), and sends it to the first base station eNB (S510). The specific process is the same as step S540 of Operation Example 2-1. Upon receiving the Deactivate Bearer Request message from the switching station MME, on the basis of the received message, the first base station eNB generates an RRC Connection Reconfiguration message (radio resource control message), and sends it to the user equipment UE (S530). In a manner similar to Operation Example 2-1, the user equipment UE deletes the context information on the PDN connection PC stored in the user equipment UE, and sends an RRC Connection Reconfiguration Complete message to the first base station eNB (S550). Upon receiving the RRC Connection Reconfiguration Complete message, the first base station eNB sends a Deactivate Bearer Response message to the switching station MME (S570).

Upon receiving the Deactivate Bearer Response message from the first base station eNB, the switching station MME generates a Deactivate Bearer Request message (first path release request message), and sends it to the second base station PhNB (S590). The specific process is the same as step S500 of Operation Example 2-1. Upon receiving the Deactivate Bearer Request message from the switching station MME, the second base station PhNB deletes the context information on the PDN connection PC stored in the second base station PhNB in the same manner as in Operation Example 2-1.

As described above, in a manner similar to Operation Example 2-1, context information with regard to a PDN connection PC stored in the gateway apparatus GW, the second base station PhNB, and the user equipment UE is deleted. As a result, the PDN connection PC is fully released (S610). Thereafter, control messages each indicating that release operation has been completed are sequentially exchanged (S630 to S660).

2(3). Effects of Present Embodiment

According to the above-described second embodiment, since the switching station MME controls the second base station PhNB and the user equipment UE so as to release a PDN connection PC (executes separation (extraction) of path release request messages), it is possible to release the PDN connection PC (U-plane path) having been established via the second base station PhNB, which cannot exchange control messages with the user equipment UE due to its limited control functions, in a manner similar to in the first embodiment.

Additionally, since the switching station MME executes separation (extraction) of the path release request messages, processing load in the first base station eNB can be reduced in comparison with a way in which the first base station eNB separates (extracts) path release request messages. From a different point of view, the first embodiment in which the first base station eNB separates (extracts) path release request messages can reduce processing load in the switching station MME.

### 3. Third Embodiment

3(1). Structure of Radio Communication System

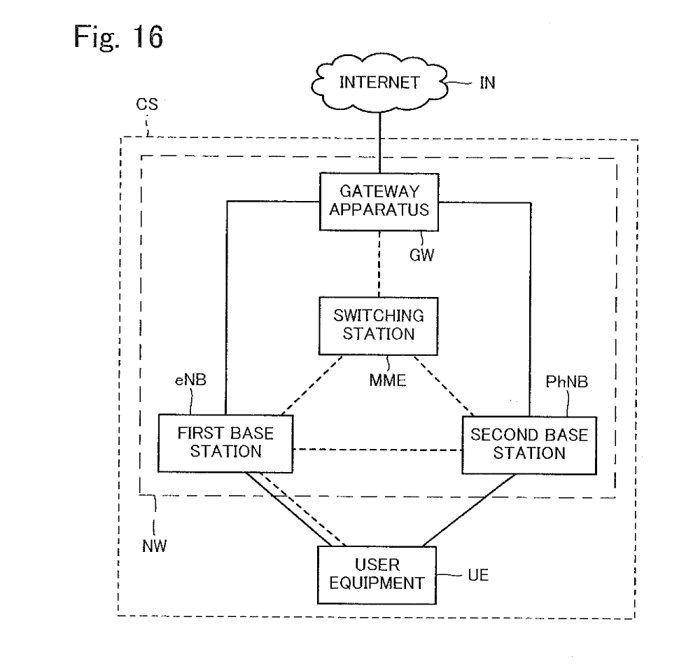

FIG. 16 is a block diagram showing a radio communication system CS according to a third embodiment of the present invention. The first base station eNB and the second base station PhNB according to the third embodiment are interconnected, and are connected with the switching station MME and the gateway apparatus GW, respectively. C-plane interfaces exist between the first base station eNB and the second base station PhNB, between the first base station eNB and the switching station MME, and between the second base station PhNB and the switching station MME. In the same manner as in the first embodiment, a C-plane interface does not exist between the second base station PhNB and the user equipment UE.

3(2). Release Operation of PDN Connection

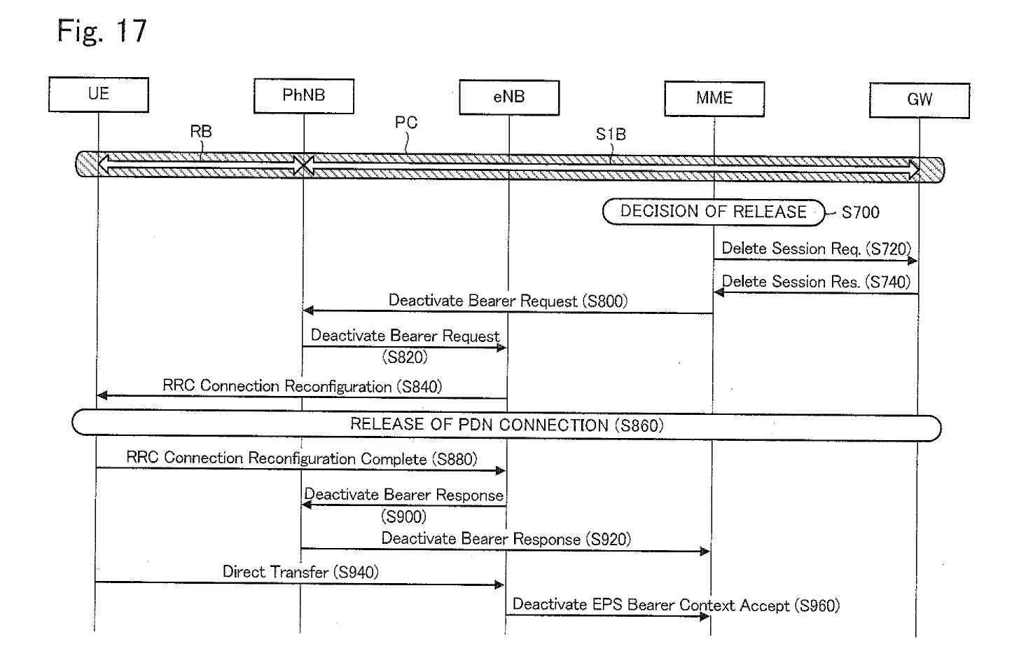

With reference to FIG. 17, FIG. 4, and FIG. 14, an example of a release operation of a PDN connection PC according to the third embodiment will be described. In general, on the basis of a path release request message from the switching station MME, the second base station PhNB controls the second base station PhNB itself and the user equipment UE so as to release a PDN connection PC (executes separation (extraction) from the path release request message). Control of the user equipment UE is made via the first base station eNB.

FIG. 17 is flow diagram showing an example of a release operation of a PDN connection. For the example in FIG. 17, in the same manner as for FIGS. 3 and 13, assume that a C-plane path has been established between the user equipment UE and the switching station MME via the first base station eNB, and that a PDN connection PC has been established between the user equipment UE and the gateway apparatus GW via the second base station PhNB. Step S700 to step S740 are the same as step S100 to step S140 in FIG. 3, and therefore, description thereof will be omitted.

Upon receiving the Delete Session Response message from the gateway apparatus GW, the switching station MME generates a Deactivate Bearer Request message (path release request message) for requesting to release the PDN connection PC, and sends it to the second base station PhNB (S800). The format of the Deactivate Bearer Request message generated at step S800 is the same as that of the Deactivate Bearer Request message (FIG. 4) sent from the switching station MME to the first base station eNB at step S160 in the first embodiment (Operation Example 1-1).

Upon receiving the Deactivate Bearer Request message from the switching station MME, the second base station PhNB releases the PDN connection PC corresponding to the identifier indicated by the EPS Bearer List field included in the received message (i.e., deletes the context information on the PDN connection PC stored in the second base station PhNB).

Then, the second base station PhNB generates a Deactivate Bearer Request message for the first base station eNB on the basis of the received Deactivate Bearer Request message, and sends it to the first base station eNB (S820). The format of the Deactivate Bearer Request message generated at step S820 is the same as that of the Deactivate Bearer Request message (FIG. 14) sent from the switching station MME to the first base station eNB at step S540 in the second embodiment (Operation Example 2-1), and contains the NAS Message field that includes the Deactivate EPS Bearer Context Request message (control message of the non-access stratum).

As described above, at step S820, the second base station PhNB separates (extracts) elements necessary for controlling the user equipment UE from among elements included in the Deactivate Bearer Request message from the switching station MME, and produces a new Deactivate Bearer Request message.

Upon receiving the Deactivate Bearer Request message from the second base station PhNB, on the basis of the received message, the first base station eNB generates an RRC Connection Reconfiguration message (radio resource control message), and sends it to the user equipment UE (S840). The specific process is the same as step S560 in the second embodiment (Operation Example 2-1). Upon receiving the RRC Connection Reconfiguration message from the first base station eNB, the user equipment UE releases the PDN connection PC on the basis of the control message of the non-access stratum included in the received message. In other words, the user equipment UE deletes the context information on the PDN connection PC stored in the user equipment UE.

As described above, in a manner similar to the first and second embodiments, context information with regard to a PDN connection PC stored in the gateway apparatus GW, the second base station PhNB, and the user equipment UE is deleted. As a result, the PDN connection PC is fully released (S860). Thereafter, control messages each indicating that release operation has been completed are sequentially exchanged (S880 to S960).

3(3). Structure of Second Base Station

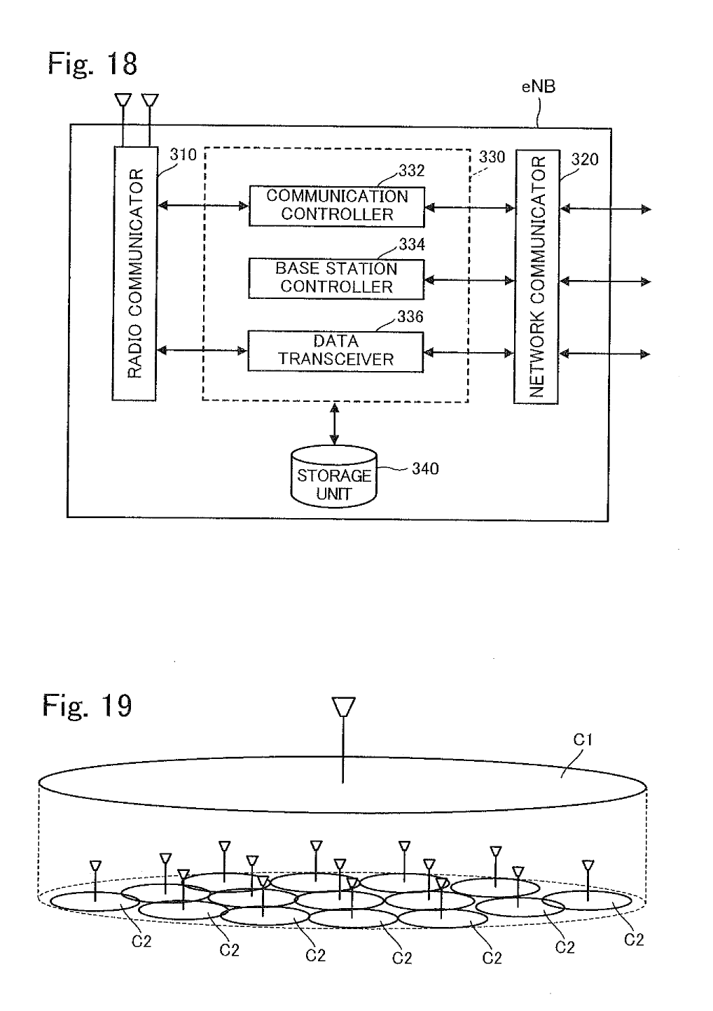

FIG. 18 is a block diagram showing the structure of a second base station PhNB according to the present embodiment. In addition to the aforementioned communication controller 332 and data transceiver 336, the controller 330 of the second base station PhNB includes a base station controller 334. The base station controller 334 is an element for controlling communication with other base stations (such as the first base station eNB) on the basis of instructions (control messages) from upper nodes (such as the switching station MME), and exchanges control signals with the first base station eNB and the switching station MME via the network communicator 320.

The base station controller 334 is, as well as the communication controller 332 and the data transceiver 336, a functional block accomplished by the fact that a CPU (not shown) in the second base station PhNB executes a computer program stored in the storage unit 340 and operates in accordance with the computer program.

3(4). Effects of Present Embodiment

According to the above-described third embodiment, on the basis of a path release request message from the switching station MME, the second base station PhNB controls the second base station PhNB itself and the user equipment UE so as to release a PDN connection PC (executes separation (extraction) from the path release request message). Control of the user equipment UE is made via the first base station eNB. Therefore, in a manner similar to in the first embodiment, it is possible to release the PDN connection PC (U-plane path) having been established via the second base station PhNB, which cannot exchange control messages with the user equipment UE due to its limited control functions.

Additionally, since the second base station PhNB executes separation (extraction) from the path release request message, processing load in the first base station eNB can be reduced in comparison with a way in which the first base station eNB separates (extracts) path release request messages.

### 4. Modifications

Various modifications may be applied to the above-described embodiments. Specific modifications are exemplified below. Two or more selected from among the above-described embodiments and exemplifications stated below may be combined as long as there is no conflict.

4(1). Modification 1

In the above-described embodiments, a release operation of a single PDN connection PC is executed. The release operation is used for releasing a single PDN connection PC in a case in which the PDN connection PC has been established via the second base station PhNB. The release operation is used for releasing a single PDN connection PC among two or more PDN connections PC having been established via the second base station PhNB.

4(2). Modification 2

In the above-described embodiments, the gateway apparatus GW is described as a single apparatus. However, the gateway apparatus GW may be constituted of multiple apparatuses, for example, a serving gateway (Serving Gateway) and a PDN gateway (Packet Data Network Gateway) stipulated in the LTE/SAE.

4(3). Modification 3

In the first embodiment, the first base station eNB separates (extracts) elements necessary for controlling the second base station PhNB from among the elements included in the Deactivate Bearer Request message (FIG. 4) from the switching station MME, and produces a new Deactivate Bearer Request message (FIG. 5). Alternatively, the Deactivate Bearer Request message transmitted by the switching station MME to the first base station eNB may contain an encapsulated Deactivate Bearer Request message for the second base station PhNB (FIG. 5). In accordance with this modification, it is unnecessary to produce the new Deactivate Bearer Request message, so that processing load in the first base station eNB can be reduced.

In the third embodiment, the second base station PhNB separates (extracts) elements necessary for controlling the user equipment UE from among the elements included in the Deactivate Bearer Request message (FIG. 4) from the switching station MME, and produces a new Deactivate Bearer Request message (FIG. 14). Alternatively, the Deactivate Bearer Request message transmitted by the switching station MME to the second base station PINS may contain an encapsulated Deactivate Bearer Request message for the first base station eNB (FIG. 14). In accordance with this modification, it is unnecessary to produce the new Deactivate Bearer Request message, so that processing load in the second base station PhNB can be reduced.

4(4). Modification 4

In the above-described embodiments, the size of a cell C formed by and around each base station (range in which radio waves will effectively reach) is not limited. For example, the first base station eNB may have higher radio transmission capabilities (average transmission power, maximum transmission power, etc.) in comparison with those of the second base station PhNB, so that the cell formed by the first base station eNB (macrocell C1) may be larger than the cell formed by the second base station PhNB (small cell C2). In this construction, it is preferable that small cells C2 be formed in a multilayered way (i.e., overlaid) inside the macrocell C1, for example, as shown in FIG. 19. As a matter of convenience of illustration, the plane in which the macrocell C1 lies is different from the plane in which the small cells C2 lie, but in fact, the macrocell C1 and the small cells C2 can be overlaid in the same plane (such as on a geosphere).

Let us assume that Modification 4 is applied in the third embodiment. In Modification 4, the small cells C2 are smaller than the macrocell C1, so that in order to cover the same area, the number of the second base stations PhNB is greater than the number of the first base stations eNB. In addition, the number of the user equipments UE visiting a small cell C2 is likely to be less the number of the user equipments UE visiting a macrocell C1. As described above, in the third embodiment, the second base station PhNB executes separation (extraction) from the path release request message for controlling the user equipment UE. Accordingly, if Modification 4 is applied in the third embodiment, load of control processing can be dispersed in comparison with a way in which the switching station MME or the first base station eNB executes separation (extraction) of the path release request message.

4(5). Modification 5

In the above-described embodiments, the second base station PhNB does not exchange control messages with the user equipment UE. However, the second base station PhNB may exchange control messages of lower layers (for example, the physical layer and the media access control layer) with the user equipment UE. Even in this modification, the second base station PhNB does not exchange signals for radio resource control (control messages of the radio resource control layer) with the user equipment UE.

4(6). Modification 6

The user equipment UE may be of any type of device that can perform radio communication with each base station (the first base station eNB and the second base station PhNB). The user equipment UE may be a cell phone terminal, e.g., a feature phone or a smart phone, a desk-top type personal computer, a laptop personal computer, a UMPC (ultra-mobile personal computer), a portable game machine, or other type of radio terminal.

4(7). Modification 7

In each of the elements in the radio communication system CS (the user equipment UE, the first base station eNB, the second base station PhNB, the switching station MME, and the gateway apparatus GW), functions executed by the CPU may be executed by hardware or a programmable logic device, such as an FPGA (Field Programmable Gate Array) or a DSP (Digital Signal Processor), instead of the CPU.

4(8). Modification 8

The frequency band of radio waves sent by the first base station eNB may be different from the frequency band of radio waves sent by the second base station PhNB. For example, let us assume that the first base station eNB uses a first frequency band (for example, a 2 GHz band) for wireless communication, and the second base station PhNB uses a second frequency band (for example, a 3.5 GHz band) higher than the first frequency band. Since the higher the frequency, the higher the propagation loss, wireless communication using the first frequency band is more stable than wireless communication using the second frequency band. As described concerning the above-described embodiments, the first base station eNB executes transmission and reception of control signals (C-plane communication) to and from the user equipment UE. Accordingly, if Modification 8 is adopted, transmission and reception of control signals (C-plane communication) is executed at the first frequency band with higher stability, which results in more reliable control of the user equipment UE.

REFERENCE SYMBOLS

| | |
|---|---|
| UE: User Equipment | 110: Radio Communicator |
| 120: Controller | 122: Radio Controller |

| | |
|---|---|
| 124: Data Transceiver | 130: Storage Unit |

| | |
|---|---|
| eNB: First Base Station | 210: Radio Communicator |

| | |
|---|---|
| 220: Network Communicator | 230: Controller |
| 232: Base Station Controller | 234: Radio Controller |
| 236: Data Transceiver | 240: Storage Unit |
| PhNB: Second Base Station | 310: Radio Communicator |
| 320: Network Communicator | 330: Controller |

| | |
|---|---|
| 332: Communication Controller | 334: Base Station Controller |

| | |
|---|---|
| 336: Data Transceiver | 340: Storage Unit |

| | |
|---|---|
| MME: Switching Station | 410: Network Communicator |
| 420: Controller | 422: Decision Unit |
| 424: Communication Controller | 430: Storage Unit |
| GW: Gateway Apparatus | 510: Network Communicator |

520: External Network Communicator

| | |
|---|---|
| 530: Controller | 532: Communication Controller |
| 534: Data Transceiver | 540: Storage Unit |
| C: Cell | C1: Macrocell |
| C2: Small Cell | CS: Radio Communication System |
| IN: Internet | NW: Network |
| PC: PDN Connection | RB: Radio Bearer |

S1B: S1 Bearer

1. A radio communication system comprising:
at least one user equipment;
multiple base stations comprising a first base station configured to execute radio resource control of the user equipment through a control plane path, which is a logical path established for the user equipment, and a second base station configured not to execute radio resource control of the user equipment;
at least one gateway apparatus; and
a switching station configured to control at least one user plane path, which is a logical path established between the user equipment and the gateway apparatus,
wherein the switching station comprises:
a decision unit configured to decide whether or not a user plane path having been established between the user equipment and the gateway apparatus via the second base station should be released; and
a communication controller configured to transmit a non-access stratum message to the user equipment through the control plane path established between the first base station and the user equipment in a case in which the decision unit decides that the user plane path should be released, the non-access stratum message instructing the user equipment to release the user plane path.

2. The radio communication system according to claim 1, wherein
the communication controller of the switching station is configured to transmit a path release request message including an identifier of the user plane path to be released and the non-access stratum message to the first base station in a case in which the decision unit decides that the user plane path should be released,
wherein the first base station comprises:
a base station controller configured to transmit a path release request message for the second base station on the basis of the path release request message received from the switching station; and
a radio controller configured to transmit a radio resource control message including the non-access stratum message included in the path release request message received from the switching station to the user equipment,
wherein the second base station comprises:
a communication controller configured to release the user plane path corresponding to the identifier and established via the second base station, on the basis of the path release request message for the second base station received from the first base station, and
wherein the user equipment comprises:
a radio controller configured to release the user plane path, on the basis of the non-access stratum message included in the radio resource control message received from the first base station.

3. The radio communication system according to claim 2, wherein
the base station controller of the first base station is configured to separate the identifier of the user plane path to be released from the path release request message received from the switching station, to include the identifier in the path release request message for the second base station, and to transmit the path release request message for the second base station to the second base station, and
the radio controller of the first base station is configured to separate the non-access stratum message from the path release request message received from the switching station, to include the non-access stratum message in the radio resource control message, and to transmit the radio resource control message to the user equipment.

4. The radio communication system according to claim 1, wherein
the communication controller of the switching station is configured to transmit a first path release request message including the identifier of the user plane path to be released to the second base station, and to transmit a second path release request message including the non-access stratum message to the first base station in a case in which the decision unit decides that the user plane path should be released,
wherein the second base station comprises:
a communication controller configured to release the user plane path corresponding to the identifier and established via the second base station, on the basis of the first path release request message received from the switching station,
wherein the first base station comprises:
a radio controller configured to transmit a radio resource control message including the non-access stratum message included in the second path release request message received from the switching station to the user equipment, and
wherein the user equipment comprises:
a radio controller configured to release the user plane path, on the basis of the non-access stratum message included in the radio resource control message received from the first base station.

5. The radio communication system according to claim 1, wherein
the communication controller of the switching station is configured to transmit a path release request message including an identifier of the user plane path to be released and the non-access stratum message to the second base station in a case in which the decision unit decides that the user plane path should be released,
wherein the second base station comprises:
a communication controller configured to release the user plane path corresponding to the identifier and established via the second base station, on the basis of the path release request message received from the switching station; and a base station controller configured to transmit a path release request message for the first base station including the non-access stratum message,
wherein the first base station comprises:
a radio controller configured to transmit a radio resource control message including the non-access stratum message included in the path release request message for the first base station received from the second base station to the user equipment, and
wherein the user equipment comprises:
a radio controller configured to release the user plane path, on the basis of the non-access stratum message included in the radio resource control message received from the first base station.

6. The radio communication system according to claim 5, wherein
the radio controller of the second base station is configured to separate the non-access stratum message from the path release request message received from the switching station, to include the non-access stratum message in the path release request message for the first base station, and to transmit the path release request message for the first base station to the first base station.

7. A communication control method in a radio communication system comprising:
at least one user equipment;
multiple base stations comprising a first base station configured to execute radio resource control of the user equipment through a control plane path, which is a logical path established for the user equipment, and a second base station configured not to execute radio resource control of the user equipment;
at least one gateway apparatus; and
a switching station configured to control at least one user plane path, which is a logical path established between the user equipment and the gateway apparatus,
the communication control method comprising:
at the switching station,
deciding whether or not a user plane path having been established between the user equipment and the gateway apparatus via the second base station should be released; and
transmitting a non-access stratum message to the user equipment through the control plane path established between the first base station and the user equipment in a case in which it is decided that the user plane path should be released, the non-access stratum message instructing the user equipment to release the user plane path.
